(19) United States
(12) Patent Application Publication
(10) Pub. No.: US 2008/0116796 A1
(43) Pub. Date: May 22, 2008

(54) Plasma display panel (PDP)

(76) Inventors: Young-Kuk Kwon, Suwon-si (KR); Seung-Beom Seo, Suwon-si (KR)

Correspondence Address: Robert E. Bushnell, Suite 300, 1522 K Street, N.W., Washington, DC, 20005-1202, US

(21) Appl. No.: 11/797,764

(22) Filed: May 7, 2007

(30) Foreign Application Priority Data
Nov. 17, 2006 (KR) 10-2006-0113972

(51) Int. Cl. H01J 17/02

(52) U.S. Cl. 313/582

(57) ABSTRACT

A Plasma Display Panel (PDP) includes first and second substrates facing each other and overlapping each other, and frit that is provided along a periphery of the overlapping portion between the first and second substrates to seal the first and second substrates together. The frit includes a plurality of wide portions each having a predetermined length and a plurality of connection portions interconnecting the adjacent wide portions. Each connection portion has a width less than that any one of the plurality of wide portions.

### CLAIM OF PRIORITY

This application makes reference to, incorporates the same herein, and claims all benefits accruing under 35 U.S.C. § 119 from an application for PLASMA DISPLAY PANEL earlier filed in the Korean Intellectual Property Office on the 17^{th} of Nov. 2006 and there duly assigned Serial No. 10-2006-0113972.

### BACKGROUND OF THE INVENTION

1. Field of the Invention

The present invention relates to a Plasma Display Panel (PDP) that can minimize an amount of an impurity gas remaining in a discharge space by maximizing exhaust efficiency and thus can improve a display quality thereof.

2. Description of Related Art

Generally, a Plasma Display Panel (PDP) is a display device that can display an image using red, green and blue visible light created by exciting phosphors using vacuum ultraviolet (VUV) rays emitted from a plasma generated by a gas discharge.

For example, in an Alternating Current (AC) PDP, address electrodes are formed on a rear substrate. The address electrodes are covered by a dielectric layer. Barrier ribs are arranged in a stripe pattern on the dielectric layer between the address electrodes. Red, green and blue phosphor layers are formed on the barrier ribs. A plurality of display panels, each having a pair of sustain and scan electrodes, are arranged on an opposite surface of the front surface to the rear surface. The display electrodes extend in a direction crossing the address electrodes. The display electrodes are covered by a dielectric layer and an MgO protective layer. Discharge cells are formed at regions where the address electrodes formed on the rear substrate cross the sustain and scan electrodes formed on the front substrate. Millions or more of the discharge cells are arranged in a matrix pattern in the PDP.

In order to manufacture the PDP, a sealing/exhaust process is required. The sealing/exhaust process is one of the processes that determine the characteristics of the PDP.

In the sealing/exhaust process, front and rear substrates are sealed together by frit by heating the front and rear substrates in a state where an assembling tolerance between the front and rear substrates is maintained. The impurity gas then remaining in the internal discharge space of the PDP is heated for a long time and exhausted. Next, a discharge gas is injected into the internal discharge space of the PDP and an exhaust pipe is sealed and removed.

In the above-described sealing/exhaust process, since the front and rear substrates are sealed together at a high pressure and the inner discharge space is exhausted, the gas flowing through a small gap between the substrate and the barrier ribs is significantly limited. That is, when the method of exhausting the discharge space after the substrates are sealed together is used, an exhaust conductance is reduced (an exhaust resistance increases) and thus the time taken for exhausting the impurity gas increases. In addition, an amount of the impurity gas remaining in the discharge space increases and thus a degree of vacuum cannot reach a desired level.

In order to solve the above problem, there is a need to perform the sealing/exhaust process under a high exhaust conductance environment.

### SUMMARY OF THE INVENTION

The present invention provides a Plasma Display Panel (PDP) that can minimize an amount of an impurity gas remaining in a discharge space by maximizing exhaust efficiency and thus can improve a display quality thereof.

According to an embodiment of the present invention, a Plasma Display Panel (PDP) is provided including: first and second substrates facing each other and overlapping each other, and frit that is provided along a periphery of the overlapping portion between the first and second substrates to seal the first and second substrates together; the frit includes a plurality of wide portions each having a predetermined length and a plurality of connection portions interconnecting the adjacent wides portions, each connection portion having a width less than that of any of the plurality of wide portions. The frit may contain bubbles.

A length of each connection portion may be less than the width of any of the plurality of wide portions. The predetermined length of each wide portion may range from 3 mm to 10 mm and a length of the connection portion may range from 0.5 mm to 5 mm. The width of each wide portion is 1.2-1.5 times the length of any of the plurality of connection portions.

A total sum of the lengths of the connection portions may be 5-50% of an overall length of the periphery.

In another embodiment of the present invention, a Plasma Display Panel (PDP) is provided including: first and second substrates facing each other and overlapping each other, and frit that is provided along a periphery of the overlapping portion between the first and second substrates to seal the first and second substrates together, the frit having a first width and at least one portion of the frit along the periphery having a second width different from the first width.

The second width may be less than the first width. The portion having the second width is arranged on each side of a rectangular periphery.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a schematic exploded perspective view of a vacuum exhaust/sealing process of a PDP according to an embodiment of the present invention;

FIG. 2 is a perspective view of front and rear substrates being separated from each other during a vacuum exhaust process;

FIG. 3 is a sectional view taken along line III-III of FIG. 2;

FIG. 4 is a perspective view of a PDP according to an embodiment of the present invention;

FIG. 5 is a top plane view of frit between front and rear substrates after a vacuum sealing is performed; and

FIG. 6 is an enlarged view of wide portions and connection portions between the wide portions after the front and rear substrates have been sealed together.

### DETAILED DESCRIPTION OF THE INVENTION

The present invention is described more fully below with reference to the accompanying drawings, in which embodiments of the present invention are shown. The present invention may, however, be embodied in many different forms and should not be construed as being limited to the embodiments set forth herein. Rather, these embodiments are provided so that this disclosure will be thorough and complete, and will fully convey the concept of the present invention to those skilled in the art. Wherever possible, the same reference numbers will be used throughout the drawings to refer to the same or like parts.

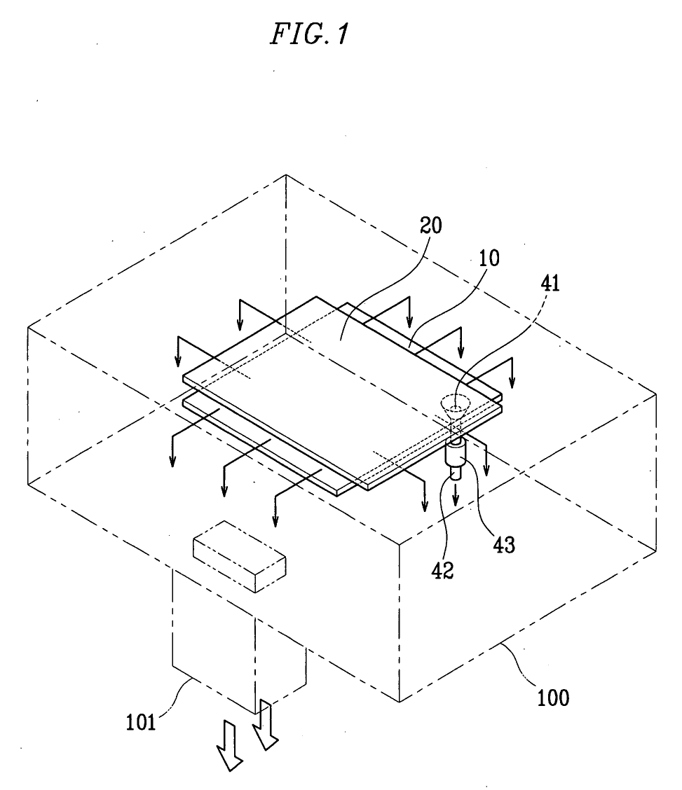

FIG. 1 is a schematic exploded perspective view of a vacuum exhaust/sealing process of a Plasma Display Panel (PDP) according to an embodiment of the present invention.

Referring to FIG. 1, one vacuum exhaust/sealing process among a variety of processes for manufacturing a PDP is shown. In the vacuum exhaust/sealing process, a first substrate (hereinafter, “a rear substrate”) 10 and a second substrate (hereinafter, “a front substrate”) 20 are arranged in a high exhaust conductance state (a low exhaust resistance state). In this state, the exhaust is performed for the front and rear substrates 20 and 10.

A vacuum chamber 100 is used to perform a vacuum exhaust/sealing process for the front and rear substrates 20 and 10. The vacuum chamber 100 is provided with an exhaust aperture 101 connected to a vacuum exhaust system (not shown). When the vacuum exhaust system is driven, the vacuum chamber 100 is exhausted to form a vacuum atmosphere under which the exhaust/sealing process for the front and rear substrates 20 and 10 is performed.

The front and rear substrates 20 and 10 loaded in the vacuum chamber 100 are arranged in a high exhaust conductance state. That is, the front and rear substrates 20 and 10 are maintained in a low exhaust resistance state during the exhaust process.

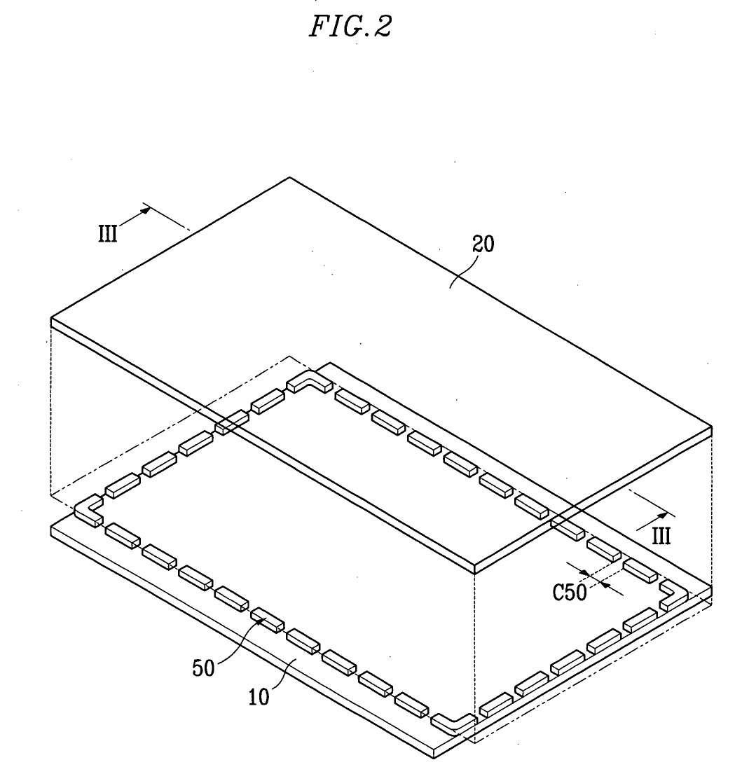

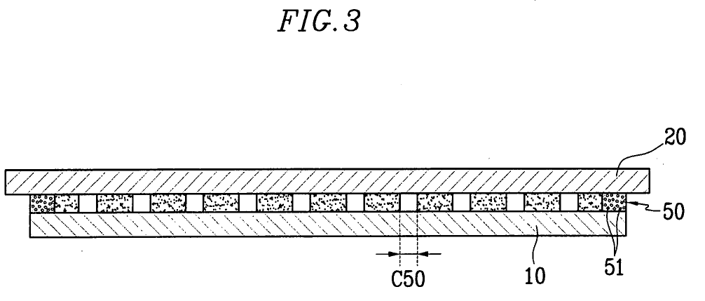

For example, as shown in FIGS. 2 and 3, the front and rear substrates 20 and 10 are separated from each other and are not completely sealed together by frit 50. That is, the front substrate 20 is arranged on the rear substrate 10 by gravity.

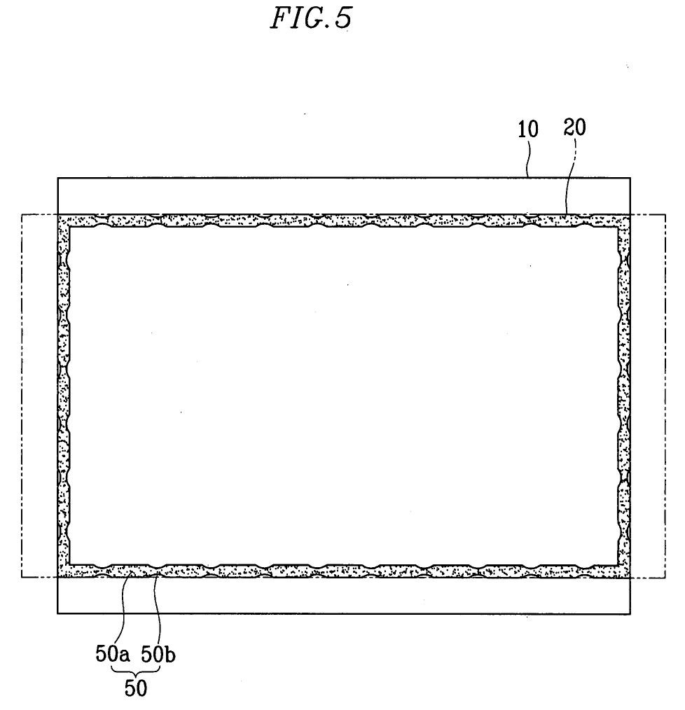

In addition, the frit 50 is not deposited on an entire periphery of the front and rear substrates 20 and 10 but is partially deposited on the periphery of the front and rear substrates 20 and 10. That is, pieces of frit 50 are arranged along the periphery and spaced apart from each other. The periphery is formed in a rectangular shape formed by connecting two lateral side edges of the rear substrates 10 to two longitudinal side edges of the front substrate 20 (see FIGS. 2 and 5).

The pieces of frit 50 maintain their height during the exhaust process to provide the high exhaust conductance. However, during the sealing process, the pieces of frit join together along the periphery. That is, the front and rear substrates 20 and 10 are sealed together by the frit 50.

The front and rear substrates 20 and 10 are loaded in the vacuum chamber 100 for the exhaust/sealing process after they have gone through advanced processes.

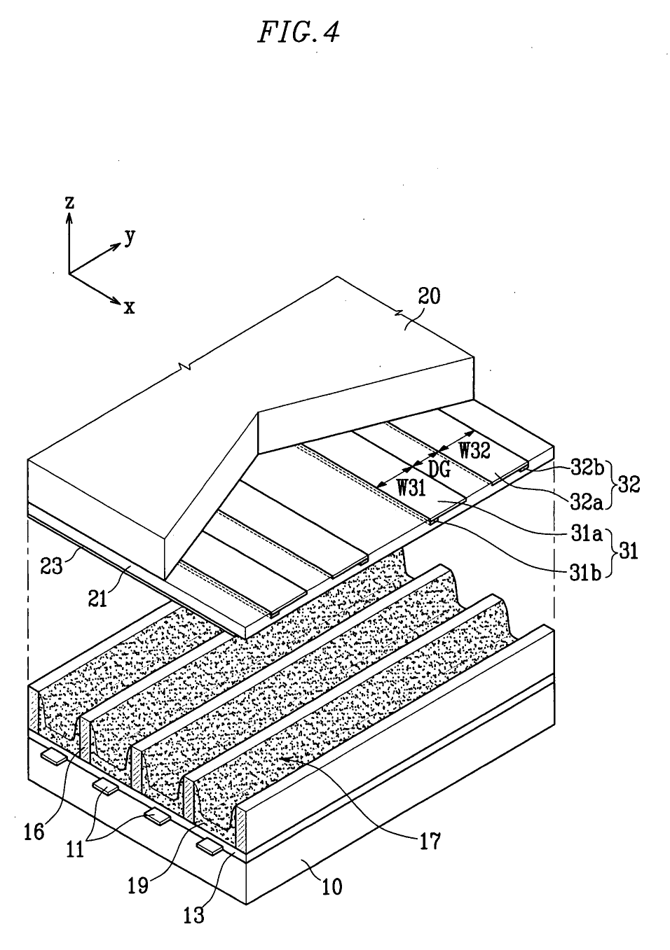

In order to describe the exhaust/sealing process in more detail, a structure of a PDP is described first with reference to FIG. 4. FIG. 4 is a perspective view of a PDP according to an embodiment of the present invention.

Referring to FIG. 4, the PDP includes front and rear substrates 20 and 10 facing each other at a predetermined interval and sealed together, and barrier ribs 16 disposed between the front and rear substrates 20 and 10. The barrier ribs 16 are formed with a predetermined height between the front and rear substrates 20 and 10 to define a plurality of discharge cells 17. The discharge cells 17 are filled with a discharge gas (e.g., a mixture gas including neon (Ne) and xenon (Xe)) to create vacuum ultraviolet rays using a gas discharge. The discharge cells 17 have phosphor layers 19 for absorbing the vacuum ultraviolet rays and emitting visible light.

In order to display an image using the gas discharge, the PDP includes address electrodes 11, first electrodes (hereinafter, “sustain electrodes”) 31, and second electrodes (hereinafter, “scan electrodes”) 32. The address, sustain, scan electrodes 11, 31 and 32 are arranged between the front and rear substrates 20 and 10 to correspond to the discharge cells 17.

The address electrodes 11 are covered by a first dielectric layer 13 deposited on an inner surface of the rear substrate 10. The first dielectric layer 13 prevents the address electrodes 11 from being damaged by preventing positive ions or electrons from directly colliding with the address electrodes 11, and generates and accumulates wall charges. Since the address electrodes are arranged on the rear substrate 10 so as not to interfere with the irradiation of the visible light toward the front substrate 20, the address electrodes 11 may be formed of a non-transparent material. For example, the address electrodes 11 may be formed of metal, such as silver (Ag), that has a high electrical conductivity.

The barrier ribs 16 extend along the y-axis and are spaced apart from each other along the x-axis. The first barrier ribs 16 form the discharge cells in a stripe structure.

Alternatively, barrier ribs extending along the x-axis may be further provided to form the discharge cells 17 in a matrix structure.

By way of example, the phosphor layer 19 in each discharge cell 17 is formed by depositing fluorescent paste on a sidewall of the barrier ribs 16 and a surface of the first dielectric layer 13 between the barrier ribs 16, and drying and firing the deposited fluorescent paste.

The phosphor layers 19 formed in the discharge cells 17 arranged along the y-axis are formed of phosphors of an identical color. In addition, the phosphor layers 19 formed in the discharge cells 17 arranged along the x-axis are formed of a repeated pattern of red, green, and blue phosphors R, G and B.

The sustain and scan electrodes 31 and 32 are provided on an inner surface of the front substrate 20 to form surface discharge structures corresponding to the respective discharge cells 17, which can induce the gas discharge in the discharge cells 17. The sustain and scan electrodes and 32 extend along the x-axis intersecting the address electrodes 11.

Each of the sustain and scan electrodes 31 and 32 includes a transparent electrode 31a and 32a and a bus electrode 31b and 32b for supplying a voltage signal to the transparent electrode 31a and 32a. The transparent electrodes 31a and 32a are for generating the surface-discharge in the discharge cells 17. Therefore, the transparent electrodes 31a and 32a are formed of a transparent material, such as Indium Tin Oxide (ITO) to provide a sufficient aperture ratio. The bus electrodes 31b and 32b are formed of a metal having a high electrical conductivity in order to compensate for the high electrical resistance of the transparent electrodes 31a and 32a.

The transparent electrodes 31a and 32a have respectively widths W31 and W32 defined in a direction from a periphery to a central portion of the discharge cell 17 to form the surface-discharge structure. A discharge gap DG is formed between the transparent electrodes 31a and 32a at a central portion of each discharge cell 17. The bus electrodes 31b and 32b are arranged on the transparent electrodes 31a and 32a and extend along the x-axis at the peripheries of the discharge cells 17. Therefore, when a voltage signal is supplied to the bus electrodes 31b and 32b, the voltage signal is transmitted to the transparent electrodes 31a and 32a connected to the bus electrodes 31b and 32b.

The sustain and scan electrodes 31 and 32 face each other while being covered by a second dielectric layer 21. The second dielectric layer 21 protects the sustain and scan electrodes and 32 from the gas discharge, and forms and accumulates wall charges.

The second dielectric layer 21 is covered by a protective layer 23. For example, the protective layer 23 is formed of MgO to protect the second dielectric layer 21 and increases a secondary electron emission coefficient.

During the vacuum exhaust/sealing process, the rear substrate 10 is provided in a state where the address electrodes 11, the first dielectric layer 13, the barriers 16, and the phosphor layers 19 are formed thereon, and the front substrate 20 is provided in a state where the sustain and scan electrodes 31 and 32, the second dielectric layer 21, and the protective layer 23 are formed thereon (see FIG. 4).

The front and rear substrates 20 and 10, structured as shown in FIG. 4, are processed to a state as shown in FIG. 2 and overlap one another. In this state, the front and rear substrates and 10 are loaded in the vacuum chamber 100. At this point, the front and rear substrates 20 and 10 are clamped by a sealing clip (not shown).

In the exhaust process of the exhaust/sealing process, as described above, the frit 50 are not deposited on an entire periphery but only partially deposited. That is, pieces of frit 50 are deposited along the periphery with predetermined intervals. The pieces of frit 50 are formed through a screen-printing process or a dispensing process.

In this state, when the vacuum exhaust system connected to the exhaust aperture 101 operates, a vacuum pressure is formed in the vacuum chamber 100 and thus the impurity gas remaining in the discharge space of the discharge cells 17 between the front and rear substrates and 10 is exhausted.

Referring again to FIG. 1, the impurity gas is exhausted out of the discharge space though gaps C50 formed between the pieces of frit 50 at the four sides of the front and rear substrates 20 and 10 and is then exhausted to an external side of the vacuum chamber 100 through the exhaust aperture 41 and an exhaust tube 42. The front and rear substrates 20 and 10 are sealed together while exhausting the impurity gas as described above.

The above-described vacuum exhaust/sealing process performs the exhaust through the four sides of the front and rear substrates 20 and 10, and thus can further reduce the time taken for exhausting the impurity gas as compared with the conventional high pressure sealing/exhaust process using only the exhaust aperture and tube, thereby further reducing an amount of the impurity gas remaining in the discharge space.

The exhaust process for exhausting the impurity gas out of the discharge space between the front and rear substrates 20 and 10 is completed in a state where the front and rear substrates and 10 are clamped. At this point, as shown in FIG. 5, the pieces of frit 50 are joined together along the periphery, thereby sealing the front and rear substrates 20 and 10.

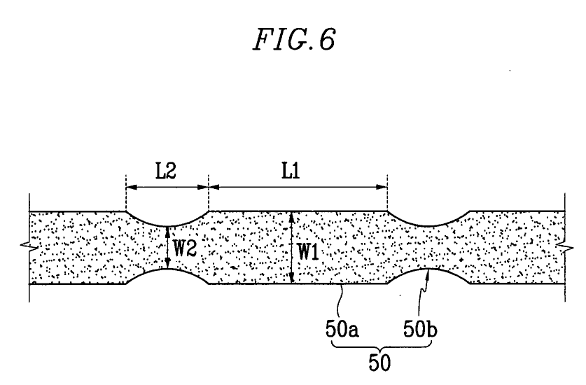

FIG. 5 is a top plane view of the frit between the front and rear substrates after the vacuum sealing has been performed. FIG. 6 is an enlarged view of wide portions and connection portions between the wide portions after the front and rear substrates have been sealed together.

When the front and rear substrates 20 and 10 are sealed together through the vacuum exhaust/sealing process, each piece of frit 50 has wide portions 50a and connection portions 50b between the wide portions 50a.

Each wide portion 50a has a first width W1 and a first length L1 and is formed on the rear substrate 10. The length L1 of each of the wide portion 50a is greater than a length of the corresponding piece of frit 50 that is depicted in FIG. 2. That is, the wide portion 50a includes a length and width of the corresponding piece of frit 50 that is deposited on the rear substrate 10, and a spread length and width that form the piece of frit 50 deposited on the rear substrate 10 spread during the sealing process.

The connection portion 50b between the adjacent wide portions 50a has a second length L2 corresponding to the spread lengths of the adjacent wide portions 50a and a second width W2. The second width W2 of the connection portion 50b is less than the first width W1 of the wide portion 50a.

The connection portion 50b are formed by the spread lengths of the adjacent wide portions 50a and thus the second width W2 of the connection portion 50b is less than the first width W1 of the wide portion 50a, thereby reducing the consumption of frit 50.

In addition, the second length L2 of the connection portion 50b is less than the first width W1 of the wide portion 50a. This allows the connection portion 50b to be formed even when the spread length of the wide portion 50a is short.

For instance, when a conventional frit is used, the first length L1 of the wide may be about 3-10 mm. The second length L2 of the connection portion may be about 0.5-5 mm. That is, the first width W1 of the wide portion 50a may be 1.2-1.5 times the second length L2 of the connection portion 50b. The first length L1 and first width W1 of the wide portion 50a and the second length L2 and second width W2 of the connection portion 50b may be varied according to the frit material.

The total sum of the lengths of the connection portions 50b may be 5-50% of the overall length of the periphery. A sealing force of the connection portion 50b is less than that of the wide portion 50a. Therefore, the connection portion 50b is formed to a level where the exhaust efficiency can be increased during the exhaust/sealing process and by which the sealing force is not excessively deteriorated.

For the case of a typical glass frit, when the total sum of the lengths of the connection portions 50b is 5% or less of the overall length of the periphery, a gap C50 between adjacent pieces of the frit 50 is too small to obtain the sufficient exhaust/sealing effect. In addition, when the total sum of the lengths of the connection portions 50b is greater than 50%, the sealing force between the front and rear substrates 20 and 10 may be excessively deteriorated. Therefore, like the second length L2 of the connection portion 50b, the total sum of the lengths of the connection portions 50b may be properly set according to the frit material.

As described above, since the exhaust/sealing process is performed under a vacuum atmosphere, the frit 50 that is not fully hardened between the front and rear substrates 20 and 10 is receives an expansion force due to the vacuum pressure acting in the vacuum chamber 100.

That is, since the frit 50 is supplied with the vacuum pressure while being hardened, bubbles may be formed therein (see FIG. 3). The bubbles 51 each has to have a diameter small enough to provide sufficient sealing strength between the front and rear substrates 20 and 10.

A diameter of each bubble 51 in the frit 50 is determined to a degree where the seal strength of the frit 50 between front and rear substrates 20 and 10 can be maintained within an allowable range. That is, the bubbles 51 deteriorate the sealing force of the frit 50. If the frit 50 can stably maintain the sealing structure between the front and rear substrates 20 and 10 even when the abnormally increased vacuum pressure is supplied to the frit 50, the diameter of the bubble 51 may be increased within this range.

In addition, when the exhaust of the impurity gas out of the space between the front and rear substrates 20 and 10 is completed, the discharge gas is injected through the exhaust tube 42, after which the exhaust tube 42 is sealed and removed by a heater 43.

The discharge gas injection process may be performed in the vacuum chamber 100 for the exhaust/sealing process or in a separate chamber (not shown).

When the PDP is driven, a reset discharge occurs by a reset pulse supplied to the scan electrodes 32 in a reset period. In a scan period (an addressing period) following the reset period, an address discharge occurs by the scan pulse supplied to the scan electrodes 32 and an address pulse supplied to the address electrodes 11. Then, in a sustain period, a sustain discharge occurs by a sustain pulse that is alternately supplied to the sustain and scan electrodes 31 and 32.

The sustain and scan electrodes 31 and 32 function as electrodes for supplying the sustain pulse required for the sustain discharge. The scan electrodes 32 function as electrodes for supplying the reset and scan pulses. The address electrodes 11 function as electrode for supplying the address pulse. The sustain, scan and address electrodes 31, 32 and 11 may vary their functions depending on voltage waveforms respectively supplied thereto. Therefore, the functions are not limited to the above case.

The PDP selects discharge cells 17 that will be turned on by the address discharge occurring by the interaction between the address and scan electrodes 11 and 32 and drives the selected discharge cells 17 using the sustain discharge occurring by the interaction between the sustain and scan electrodes 31 and 32, thereby displaying an image.

According to the PDP of the present embodiment, since pieces (wide portions) of the frit 50 are deposited on the rear substrate 10 at predetermined intervals, the exhaust conductance increases and thus the impurity gas remaining in the discharge space between the front and rear substrates 20 and 10 can be effectively exhausted under the vacuum atmosphere. In addition, the wide portions are connected to each other the connection portions 50b that are formed by spread lengths of the wide portions, which are formed by pressing the wide portions. That is, the front and rear substrates 20 and 10 are sealed together by the frit including the wide portions and the connection portions. Therefore, the impurity gas exhaust is realized before the sealing process is completed, the exhaust efficiency is improved and thus an amount of the impurity gas remaining in the discharge space is reduced, thereby improving the display quality of the PDP.

Although embodiments of the present invention have been described in detail herein, it should be clearly understood that many variations and/or modifications of the basic inventive concept herein taught still fall within the spirit and scope of the present invention, as defined by the appended claims.

What is claimed is:

1. A Plasma Display Panel (PDP) comprising:
first and second substrates facing each other and overlapping each other; and
frit arranged between the first and second substrates along a periphery of an overlapping portion of the first and second substrates to seal the first and second substrates together, the frit including a plurality of wide portions each having a predetermined length and a plurality of connection portions interconnecting the adjacent wide portions, each connection portion having a width less than that of any of the plurality of wide portions.

2. The PDP of claim 2, wherein the frit contains bubbles.

3. The PDP of claim 1, wherein a length of each connection portion is less than a width of any of the plurality of wide portions.

4. The PDP of claim 3, wherein the predetermined length of each wide portion ranges from 3 mm to 10 mm and a length of each connection portion ranges from 0.5 mm to 5 mm.

5. The PDP of claim 3, wherein the width of any of the plurality of wide portions is 1.2-1.5 times the length of any of the plurality of connection portions.

6. The PDP of claim 5, wherein a total sum of the lengths of the plurality of connection portions is 5-50% of an overall length of the periphery of an overlapping portion of the first and second substrates.

7. A Plasma Display Panel (PDP) comprising:
first and second substrates facing each other and overlapping each other; and
frit arranged along a periphery of the overlapping portion of the first and second substrates between the first and second substrates to seal the first and second substrates together, the frit having a first width and at least one portion of the frit along the periphery of the overlapping portion of the first and second substrates has a second width different from the first width.

8. The PDP of claim 7, wherein the second width is less than the first width.

9. The PDP of claim 8, wherein the periphery of the overlapping portion of the first and second substrates is rectangular and wherein at least one portion of the frit having the second width is arranged on each side of the rectangular periphery.
